(19) United States
(12) Patent Application Publication
(10) Pub. No.: US 2007/0119444 A1
(43) Pub. Date: May 31, 2007

(54) Charcoal gas lighter

(76) Inventors: Cheol Jung Yoon, La Mirada, CA (US); Jae Young Park, In Cheon (KR)

Correspondence Address: PARK LAW FIRM, 3255 WILSHIRE BLVD, SUITE 1110, LOS ANGELES, CA, 90010, US

(21) Appl. No.: 11/289,811

(22) Filed: Nov. 30, 2005

(51) Int. Cl. A47J 37/07; A47J 37/00; F24B 3/00

(52) U.S. Cl. 126/25 B

(57) ABSTRACT

A charcoal gas lighter includes a fire basket for containing briquettes of charcoal, a mesh plate and a gas burner. The fire basket has a charcoal container having an upper end and a lower end, and the upper end and lower end are open. The mesh plate that is attached near the lower end of the charcoal container, and is adapted to support the briquettes of charcoal. The gas burner supports the fire basket. Heat generated by the gas burner is guided into the fire basket whereby the briquettes of charcoal are lighted. The fire basket further includes handle, and a heat block plate that is provided between the charcoal container and the handle. The mesh plate is cone-shaped and includes a plurality of concentric rings, and a plurality of radial spokes that connect the concentric rings.

### BACKGROUND OF THE INVENTION

The present invention relates to a charcoal gas lighter. More particularly, this invention relates to a charcoal gas lighter that utilizes a commonly used gas burner so that efforts and fuel required to start the charcoal can be substantially reduced.

Briquettes of charcoal are widely used to barbecue due to their unique flavor and long standing heating fire. Charcoal is inherently not easy to light. That is, it is not easy to start fire on briquettes of charcoal. While some expensive briquettes contain volatile materials included in them in the manufacturing process to facilitate lighting by a match, etc, most briquettes require pouring light fluid onto the briquettes and igniting the fluid to light the briquettes of charcoal. This is a very inconvenient procedure involving unpleasant fumes and risk. Also the price of the lighter fluid and caution required to handle the lighter fluid have bothered many people who enjoy barbecue cooked with charcoal.

An economic, safe and convenient device for lighting briquettes of charcoal has long been in need.

### SUMMARY OF THE INVENTION

The present invention contrives to solve the disadvantages of the prior art.

An objective of the invention is to provide a simple and convenient device for lighting briquettes of charcoal.

Another objective of the invention is to provide a charcoal lighting device that is easy and safe to operate.

Still another objective of the invention is to provide a charcoal lighting device that uses less fuel to light briquettes of charcoal.

In order to achieve the above objects, the present invention provides a charcoal gas lighter that includes a fire basket, a mesh plate and a gas burner. The fire basket is for containing briquettes of charcoal. The fire basket includes a charcoal container having an upper end and a lower end. The upper end and lower end are open to allow air to pass through the charcoal container.

The mesh plate is attached near the lower end of the charcoal container. The mesh plate is adapted to support the briquettes of charcoal.

The gas burner supports the fire basket. Heat generated by the gas burner is guided into the fire basket so that the briquettes of charcoal are lighted.

The fire basket further includes a handle attached to the charcoal container, a heat block plate that is provided between the charcoal container and the handle, and one or more brackets. The handle includes a plurality of grooves that are adapted to fit with fingers of a user. The handle is attached to the charcoal container with the brackets, and the heat block plate is fixed to the brackets.

The charcoal container includes a substantially cylindrical wall. The brackets are fixed to the cylindrical wall, and the heat block plate is substantially rectangular. Preferably, the charcoal container has a diameter ranging from about 7 inch to 11 inch, and a height ranging from about 8 inch to 12 inch.

A plurality of holes are provided on the cylindrical wall so that air for burning the briquettes of charcoal may be provided through the holes in addition to the air provided through the open lower end of the charcoal container.

The charcoal container is partially inserted into the gas burner. In detail, the cylindrical wall includes a first circular protrusion near the lower end of the charcoal container. The gas burner includes a burner body, and the burner body includes a substantially cylindrical wall, an upper end and a lower end. The upper and the lower end of the burner body are open. The lower end of the charcoal container is inserted into the gas burner. The first circular protrusion of the charcoal container abuts with the upper end of the burner body.

The gas burner further includes three or more detachable legs. The cylindrical wall of the charcoal container further includes a second circular protrusion near the upper end of the charcoal container.

The mesh plate includes a plurality of concentric rings, and a plurality of radial spokes that connect the concentric rings. The mesh plate is cone-shaped, and the mesh plate is positioned inside the charcoal container. The apex of the mesh plate is directed away from the lower end of the charcoal container.

The gas burner further includes a grill that is adapted to be placed on the upper end of the burner body. The grill is used for supporting cookware when the gas burner is used for cooking rather than lighting charcoal. The grill includes two orthogonally connected grill bars. Each of the grill bars comprises two recesses, into which the cylindrical wall of the burner body is inserted.

The advantages of the present invention are: (1) the charcoal gas lighter provides a safe and convenient way of lighting charcoal; (2) the charcoal gas lighter is economical since it uses less fuel compared to prior art method or devices; and (3) the charcoal gas lighter is versatile since it can be used as a gas cooker also.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is an exploded perspective view showing a charcoal gas lighter of the present invention;

FIG. 2 is a front elevation view of the charcoal gas lighter and shows that a fire basket is assembled with a gas burner;

FIG. 3 is a perspective view of a mesh plate that is adapted to be placed inside the fire basket;

FIG. 4 is a perspective view of a grill that may be used instead of the fire basket;

FIG. 5 is a plan view of the fire basket;

FIG. 6 is a plan view of the gas burner;

FIG. 7 is a perspective view showing another fire basket with different air intake holes; and

FIG. 8 is a plan view the fire basket of FIG. 7.

### DETAILED DESCRIPTION OF THE INVENTION

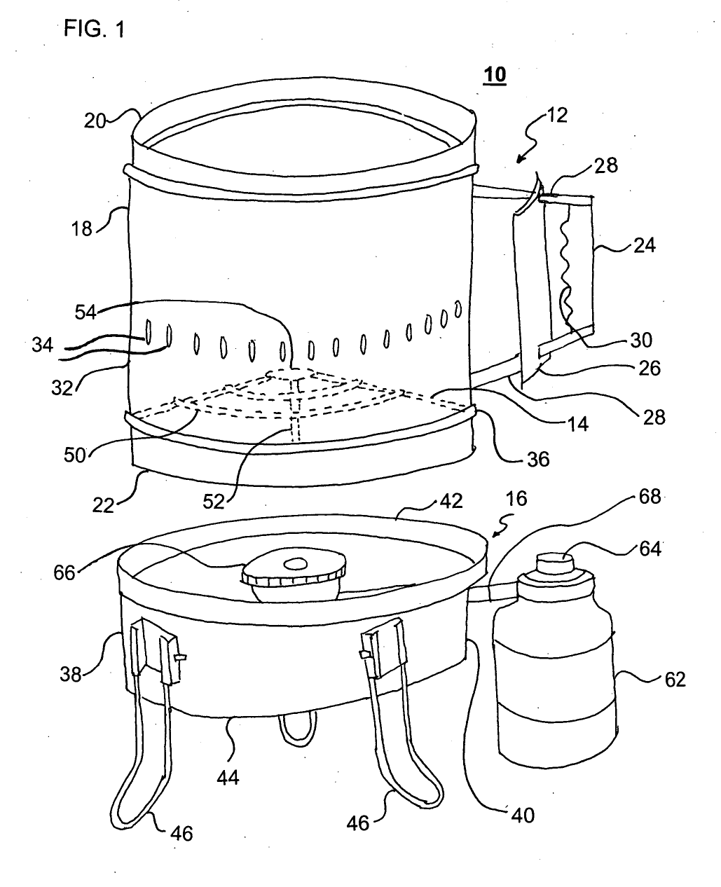

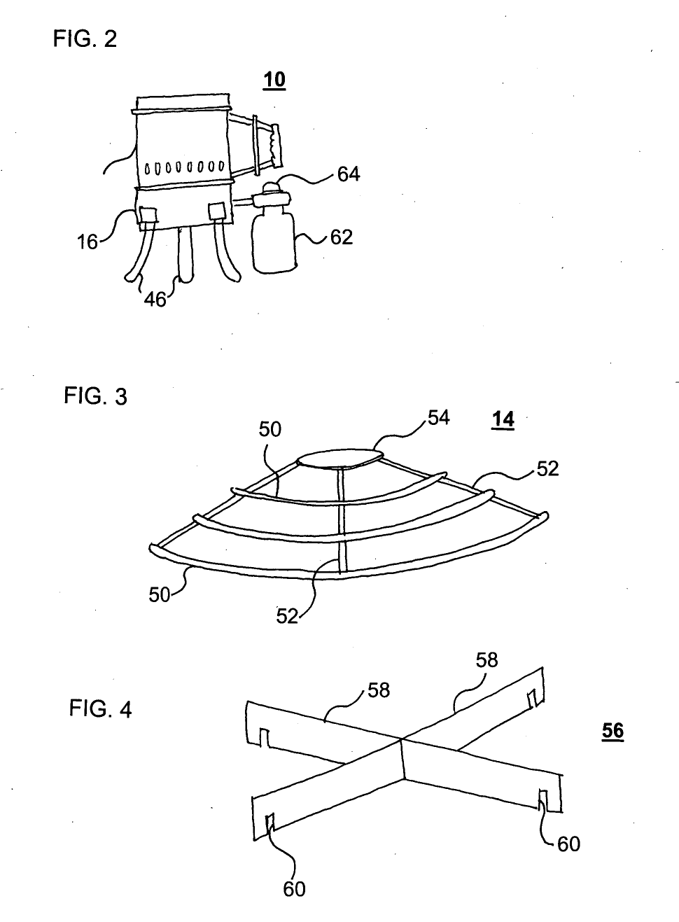

FIGS. 1 and 2 show a charcoal gas lighter 10 that includes a fire basket 12, a mesh plate 14 and a gas burner 16. The fire basket 12 is for containing briquettes of charcoal. The fire basket 12 includes a charcoal container 18 having an upper end 20 and a lower end 22. The upper end 20 and lower end 22 are open to allow air to pass through the charcoal container 18.

As shown well in FIG. 1, the mesh plate 14 is attached near the lower end 22 of the charcoal container 18. The mesh plate 14 is adapted to support the briquettes of charcoal in a way to allow free passage of air into the charcoal container 18 while supporting the briquettes so that they do not fall through the mesh plate 14.

The gas burner 16 supports the fire basket 12. Heat generated by the gas burner 16 is guided into the fire basket 12 so that the briquettes of charcoal are lighted. FIG. 3 shows that the fire basket 12 is assembled on top of the gas burner 16 so that the heat generated by the gas burner 16 is concentrated onto the briquettes of charcoal in the fire basket 12.

The fire basket 12 further includes a handle 24 attached to the charcoal container 18, a heat block plate 26 that is provided between the charcoal container 18 and the handle 24, and two brackets 28. The handle includes a plurality of grooves 30 that are adapted to fit with fingers of a user. The handle 24 is attached to the charcoal container 18 with the brackets 28, and the heat block plate 26 is fixed to the brackets 28. The handle 24 and the heat block plate 26 are made of heat-insulating material such as plastic and facilitate handling of the fire basket 12 containing hot lighted charcoal.

The charcoal container 18 includes a substantially cylindrical wall 32. The brackets 28 are fixed to the cylindrical wall 32, and the heat block plate 26 is substantially rectangular. Preferably, the charcoal container 18 has a diameter ranging from about 7 inch to 11 inch, and a height ranging from about 8 inch to 12 inch. More preferably, the charcoal container 18 has a diameter of about 9 inch, and a height of about 10 inch. These dimensions provide an optimal size for lighting the amount of charcoal commonly used.

A plurality of holes 34 are provided on the cylindrical wall 32 so that air for burning the briquettes of charcoal may be provided through the holes 34 in addition to the air provided through the open lower end 22 of the charcoal container 18.

The charcoal container 18 is partially inserted into the gas burner 16. In detail, the cylindrical wall 32 includes a first circular protrusion 36 near the lower end 22 of the charcoal container 18. The gas burner 16 includes a burner body 38, and the burner body 38 includes a substantially cylindrical wall 40, an upper end 42 and a lower end 44. The upper end 42 and the lower end 44 of the burner body 38 are open. The lower end 44 of the charcoal container 18 is inserted into the gas burner 16. The first circular protrusion 36 of the charcoal container 18 abuts with the upper end 42 of the burner body 38. This scheme provides stable support of the fire basket 12 and prevents loss of heat generated by the gas burner 16.

The gas burner 16 further includes three detachable legs 46, a gas container 62, a gas regulator 64, a burner head 66 and a gas pipe 68. The legs 46 are attached on the cylindrical wall 32 using holes (not shown) provided on the cylindrical wall. The cylindrical wall 32 of the charcoal container 18 further includes a second circular protrusion 48 near the upper end 20 of the charcoal container 18. This adds to the structural rigidity of the charcoal container 18.

As shown in FIG. 3, the mesh plate 14 includes a plurality of concentric rings 50, and a plurality of radial spokes 52 that connect the concentric rings 50. The mesh plate 14 is cone-shaped, and the mesh plate 14 is positioned inside the charcoal container 18. The apex of the mesh plate 14 is directed away from the lower end 22 of the charcoal container 18. This scheme provides effective distribution of heat from the burner head 66 to the briquettes of charcoal contained in the fire basket 12.

As shown in FIGS. 4 and 6, the gas burner 16 further includes a grill 56 that is adapted to be placed on the upper end 42 of the burner body 38. The grill 56 is used for supporting cookware when the gas burner 16 is used for cooking rather than lighting charcoal. The grill 56 includes two orthogonally connected grill bars 58. Each of the grill bars 58 comprises two recesses 60, into which the cylindrical wall 40 of the burner body 38 is inserted.

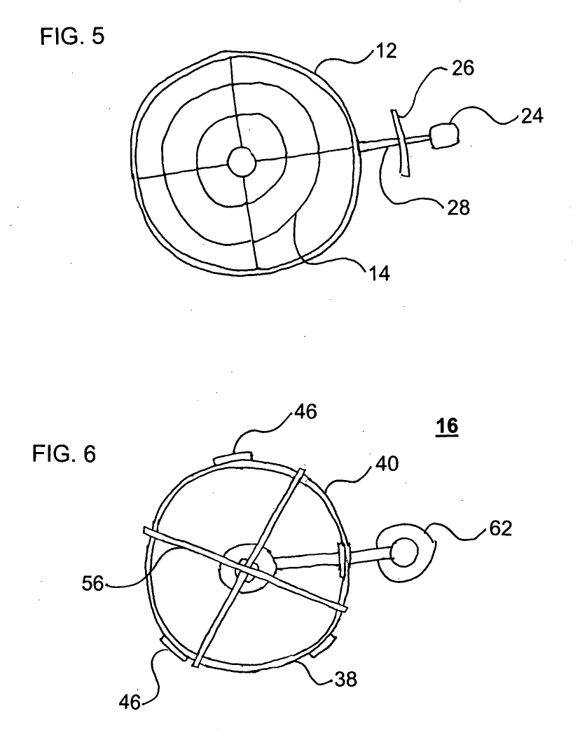

FIG. 5 shows the fire basket 12 viewed from the above, with the mesh plate 14 placed in it.

In this embodiment, the charcoal gas lighter 10 uses a standard 16.4 oz (small bottle) propane gas container as the gas container 64. Operation of the charcoal gas lighter 10 is explained below.

1) Proper amount of briquettes of charcoal are poured into the fire basket 12.

2) The gas burner 16 is started by turning on the gas regulator 64, and the fire basket 12 is placed on the gas burner 16.

3) Smoke is generated from about 5 to about 7 minutes, while the briquettes are lighted.

4) When there is no more smoke, the gas regulator 64 is turned off.

5) Even though the gas burner 16 is turned off, and no heat is transferred from the gas burner to the fire basket 12, since the briquettes positioned in lower part of the fire basket 12 has been lighted, the heat from the burning briquettes heat and light the briquettes in the upper part of the fire basket 12.

6) Burning the briquettes for additional 7˜8 minutes after turning off the gas burner 16 changes the surface color of the briquettes to ash state, which is adequate for barbecue. Then a user moves the lighted briquettes from the fire basket 12 to a barbecue grill.

7) Depending on situations, the gas burner 16 may be used as an ordinary cooking burner by putting the grill 56 instead of the fire basket 12 on the gas burner 16.

The charcoal gas lighter 10 of the present invention consumes about 0.82 oz of gas to light 5 lb of briquettes of charcoal. Therefore, it is possible to use one 16.4 oz propane gas container for lighting charcoal 20 times. Since the price of a 16.4 oz container is about $3.00, and the cost for lighting a single load of briquettes is about $0.15.

In comparison, with the conventional charcoal lighter fluid, about 1.6 FL oz of the fluid is consumed to light 1 lb of briquettes, and about 8 FL oz is required for 5 lb of briquettes. Since the common 64 FL oz lighter fluid costs about $4.20, the 64 FL oz fluid may be used 8 times, and the cost per lighting a single load of briquettes is about $0.525.

Therefore, the charcoal gas lighter is much more economical than prior art.

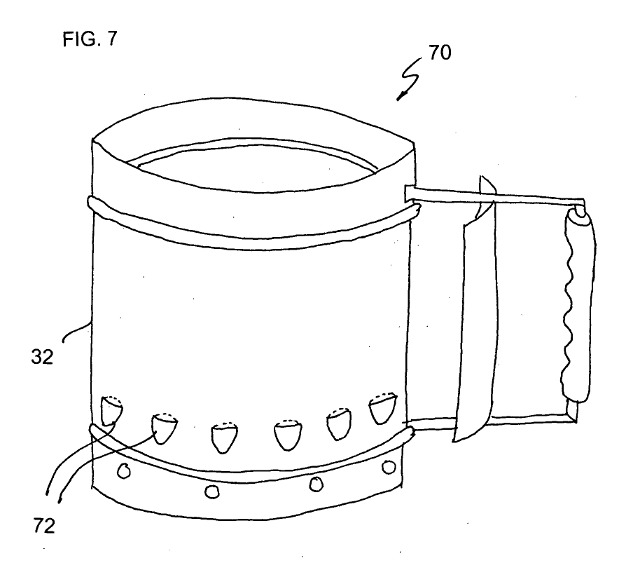

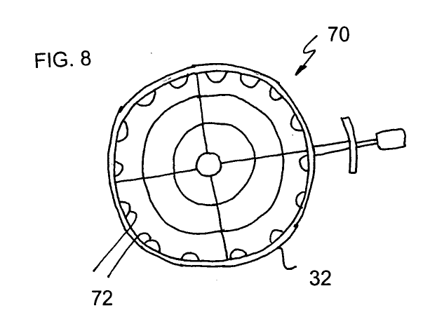

FIGS. 7 and 8 show a fire basket 70 having holes 72 for air intake. The holes 72 are recessed into the fire basket 70. Each of the holes 72 may be formed by cutting a line segment on the cylindrical wall 32 of the fire basket 70, and pressing the sheet metal below the cut line segment into the inner space of the fire basket 70. The recessed holes 72 facilitate intake of air so that the lighting of charcoal may be more effectively performed.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A charcoal gas lighter comprising:
a) a fire basket for containing briquettes of charcoal, wherein the fire basket comprises a charcoal container that comprises an upper end and a lower end, wherein the upper end and lower end are open;
b) a mesh plate that is attached near the lower end of the charcoal container, wherein the mesh plate is adapted to support the briquettes of charcoal;
and
c) a gas burner;
wherein the gas burner supports the fire basket, wherein heat generated by the gas burner is guided into the fire basket whereby the briquettes of charcoal are lighted.

2. The charcoal gas lighter of claim 1, wherein the fire basket further comprises a handle attached to the charcoal container, and a heat block plate that is provided between the charcoal container and the handle.

3. The charcoal gas lighter of claim 2, wherein the handle comprises a plurality of grooves that are adapted to fit with fingers of a user.

4. The charcoal gas lighter of claim 2, wherein the fire basket further comprises one or more brackets, wherein the handle is attached to the charcoal container with the brackets, and wherein the heat block plate is fixed to the brackets.

5. The charcoal gas lighter of claim 4, wherein the charcoal container comprises a substantially cylindrical wall.

6. The charcoal gas lighter of claim 5, wherein the brackets are fixed to the cylindrical wall, wherein the heat block plate is substantially rectangular.

7. The charcoal gas lighter of claim 5, wherein a plurality of holes are provided on the cylindrical wall whereby air for burning the briquettes of charcoal may be provided through the holes in addition to the air provided through the open lower end of the charcoal container.

8. The charcoal gas lighter of claim 5, wherein the charcoal container is partially inserted into the gas burner.

9. The charcoal gas lighter of claim 8, wherein the cylindrical wall comprises a first circular protrusion near the lower end of the charcoal container, wherein the gas burner comprises a burner body, wherein the burner body comprises a substantially cylindrical wall, an upper end and a lower end, wherein the upper and the lower end of the burner body are open, wherein the lower end of the charcoal container is inserted into the gas burner, wherein the first circular protrusion of the charcoal container abuts with the upper end of the burner body.

10. The charcoal gas lighter of claim 9, wherein the gas burner further comprises three or more detachable legs.

11. The charcoal gas lighter of claim 9, wherein the cylindrical wall of the charcoal container further comprises a second circular protrusion near the upper end of the charcoal container.

12. The charcoal gas lighter of claim 9, wherein the mesh plate comprises a plurality of concentric rings, and a plurality of radial spokes that connect the concentric rings.

13. The charcoal gas lighter of claim 12, wherein the charcoal container has a diameter ranging from about 7 inch to about 11 inch, and a height ranging from about 8 inch to about 12 inch.

14. The charcoal gas lighter of claim 9, wherein the gas burner further comprises a grill that is adapted to be placed on the upper end of the burner body.

15. The charcoal gas lighter of claim 14, wherein the grill comprises two orthogonally connected grill bars, wherein each of the grill bars comprises two recesses, into which the cylindrical wall of the burner body is inserted.

16. The charcoal gas lighter of claim 5, wherein the holes are recessed into the fire basket.

17. The charcoal gas lighter of claim 1, wherein the mesh plate comprises a plurality of concentric rings, and a plurality of radial spokes that connect the concentric rings.

18. The charcoal gas lighter of claim 17, wherein the mesh plate is cone-shaped, and wherein the mesh plate is positioned inside the charcoal container, wherein the apex of the mesh plate is directed away from the lower end of the charcoal container.

19. The charcoal gas lighter of claim 1, wherein the gas burner further comprises a grill.

20. The charcoal gas lighter of claim 19, wherein the grill comprises two orthogonally connected grill bars.
